(19) United States
(12) Patent Application Publication
(10) Pub. No.: US 2007/0061310 A1
(43) Pub. Date: Mar. 15, 2007

(54) Method for extracting injustice of component attribute information and system for extracting injustice of object attribute information

(76) Inventors: Noriyasu Ninagawa, Fujisawa (JP); Noriaki Yamamoto, Zushi (JP); Yasuhiro Hamatsuka, Yokohama (JP); Takaaki Kumazawa, Chigasaki (JP); Masanori Ikuzawa, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/506,785

(22) Filed: Aug. 21, 2006

(30) Foreign Application Priority Data
Sep. 12, 2005 (JP) 2005-263960

(51) Int. Cl. G06F 17/30

(52) U.S. Cl. 707/3

(57) ABSTRACT

A system for inspecting components by evaluating the degree of accuracy of component attribute information provided by third parties, wherein a performance unit for performing the evaluation of the component attribute information comprises a unit for extracting components similar to target components; a unit for determining the abnormality of component attribute information when the component attribute information can take limited kinds of values; a unit for determining the degree of the abnormality of the component attribute information when the component attribute information can take unlimited kinds of values; and a unit for sorting the components in the order of descending degree of abnormality of the component attribute information to clarify the reason for the evaluation result.

### INCORPORATION BY REFERENCE

The present application claims priority from Japanese application JP2005-263960 filed on Sep. 12, 2005, the content of which is hereby incorporated by reference into this application.

### BACKGROUND OF THE INVENTION

The present invention relates to a method and a system for evaluating the accuracy of component attribute information provided by third parties. More particularly, the present invention relates to a method and a system for extracting incorrect component information that are suited for quantifying the degree of accuracy of information on chemical substances contained in a component that is provided by third parties to specify the components that should be preferentially analyzed by measurement instruments.

Now, legal regulations for restricting the use of specific chemical substances are being enacted and put into force in various countries. The legal regulations include the RoHS directive (Restriction of the use of Hazardous substances: a directive for prohibiting the use of specific chemical substances), and an ELV directive (End of Life Vehicles Directive: a directive concerning used vehicles). The trend of tightening of environmental regulations of these days as foregoing suggests that the regulations will possibly be extended, resulting in the addition of chemical substances to be regulated or of regulated items other than chemical substances (such as a duty to disclose information on the effect of a product on the environment and a limitation of CO2 emission during manufacturing). Accordingly, in order to respond to these environmental regulations, assembly manufactures are requesting component suppliers (referred to as “suppliers” hereinafter, and the “suppliers” include component venders and component manufactures) to provide them with component attribute information including chemical substance information in green procurement that has been promoted by each corporation these days. The assembly manufactures are pursuing to respond to the legal regulations based on the information provided by the suppliers.

However, there is sometimes a case in which regulated chemical substances, which are not contained in components according to the information provided by the suppliers, are actually contained, which takes place due to data inputting errors, problems in measurement instruments, or the like. There is concern that once a violation is found, the corporate image of the assembly manufacture concerned is tarnished.

Therefore, in order to obtain correct component attribute information, the assembly manufactures are requesting the suppliers to submit an appended document that guarantees the accuracy of the information, such as a written guarantee of not containing the regulated chemical substances. Furthermore, the assembly manufactures are employing a system for assisting the selection of components that contain less regulated chemical substances such as one described in a Japanese Laid-open Patent Application JP-A-11-238069.

It should be noted that the “component” in the present specifications refers to a “part” that constitutes a product and exhibits part of the product's functions, and to a “material” that means a raw material necessary to manufacture the part.

The appended document like a conventional guarantee of not-containing them can not guarantee that actual attribute values match the component attribute information provided by the suppliers by 100 percent.

Additionally, the invention disclosed in the Japanese Laid-open Application JP-A-11-238069 relates to a method for assisting the selection of optimal components from among a plurality of components under given conditions. This is a method employed under a condition that the component attribute information is correct instead of a method for evaluating the accuracy of the component attribute information.

Therefore, conventionally, inspections have been performed sequentially by measurement instruments in the order in which the components are delivered or by extracting the components at random. However, in recent years, measurement manhour has become enormous because of an increase in the number of items and survey items of target components. The operations for measuring the components have prolonged the lead times from product planning to the design completion and the start of commercial production. Thus, there is a need for shortening the lead times by finding information on components that can lead to violations at an early stage.

### SUMMARY OF THE INVENTION

It is an object of the present invention to provide a method of imparting quantitative evaluation values to the accuracy degree of the component attribute information of a plurality target components, and thereby to clarify the order in which the components are analyzed. It is another object of the present invention to provide a method of specifying the chemical substances which are considered to cause poor accuracy, and thereby to enhance analytical accuracy.

In order to achieve above objects, the present invention comprises an input means for receiving a components list and evaluation conditions; an external storage device for holding component attribute information or the like; a calculation unit for performing the evaluation of the attribute information of target components; an internal storage device for storing intermediate data such as evaluation result or the like; and an output means for outputting the evaluation result.

The performance unit for performing the evaluation of the attribute information has a means for extracting components similar to the target components; a means for determining the abnormality in the component attribute information when the component attribute information takes limited values such as 0 or 1; a means for determining the degree of abnormality of the component attribute information when the component attribute information takes various values such as integers; and means for sorting the component attribute information in the order of descending degree of abnormality of the component attribute information to clarify the basis for the evaluation result.

Especially, a means for quantifying the abnormality degree of the component attribute information has a means for converting the component attribute information; and a means for quantifying the excess degree or undersize degree of the component attribute information. By implementing the present invention, it becomes possible for users to start checking preferentially from component attribute information with poor accuracy, thus enabling the users to find inaccurate components at an early stage and to facilitate the completion of qualification.

It becomes possible to find inaccurate component attribute information at an early stage to advance the completion of inspection by implementing the present invention. Moreover, the specification of the information on the chemical substances that is possibly inaccurate enhances the analytical accuracy and enables the reduction of inaccurate information and simultaneously the reduction of the risk of violating the regulation of the use of target chemical substances contained in products including ones specified in the RoHS directive.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an embodiment of the present invention;

FIG. 2 is a flow chart showing procedures of searching for similar components (step 108) in FIG. 1;

FIG. 3 is a flow chart showing procedures of determining whether containing or not-containing in FIG. 1;

FIG. 4 is a flow chart showing procedures of calculating the content ratio in FIG. 1;

FIG. 5 is an output screen image of the determination of whether containing or not-containing;

FIG. 6 is an output screen image of the calculation of the content ratio;

FIG. 7 a flow chart showing the procedures of setting an order or priority for analysis (step 111) in FIG. 1;

FIG. 8 is a system configuration block diagram when the user is an assembly manufacturer;

FIG. 9 is a system configuration block diagram when the user includes the assembly manufacture as well as a supplier;

FIG. 10 is an image diagram of a screen interface of an input means 903 in FIG. 9;

FIG. 11 is a table configuration diagram stored in a database managed by user's company;

FIG. 12 is a system configuration block; and

FIG. 13 is an image diagram of a screen interface of an input means 903 in FIG. 9.

### DETAILED DESCRIPTION OF THE EMBODIMENTS

Embodiments of the present invention will be described in the following sections with reference to drawings. In the present embodiments, information on the composition of chemical substances is given as an evaluation example of component attribute information. It should be noted that an “object” refers to a thing whose entity and concept can be identified such as software and hardware, and a “component” is an exemplary object.

### Embodiment 1

(1) An Entire System Configuration

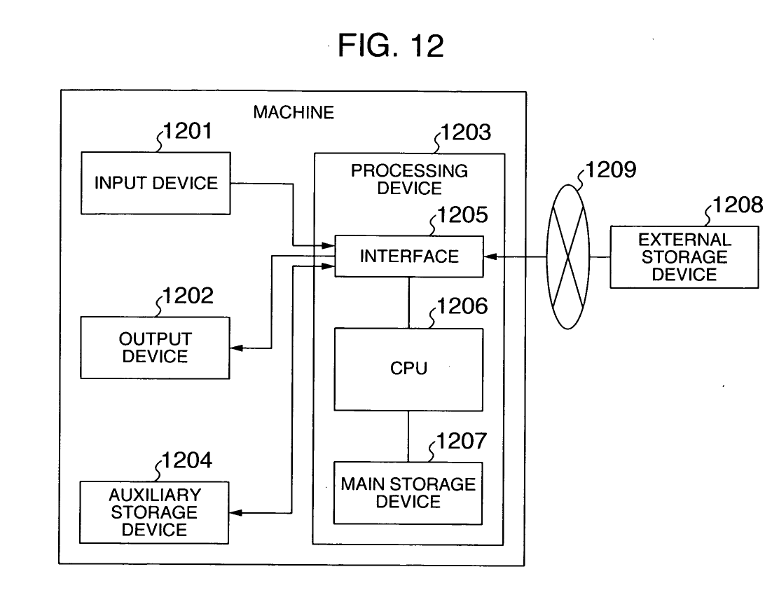

A system for extracting incorrect object attribute information is an information processing apparatus that can be connected to an external data storage unit 1208 via the Internet 1209, and comprises a main storage device 1207, a processing device (calculation unit) 1203, an auxiliary storage device (storage unit) 1204, an input device (input unit) 1201, and an output device (output unit) 1202, as is shown in FIG. 12.

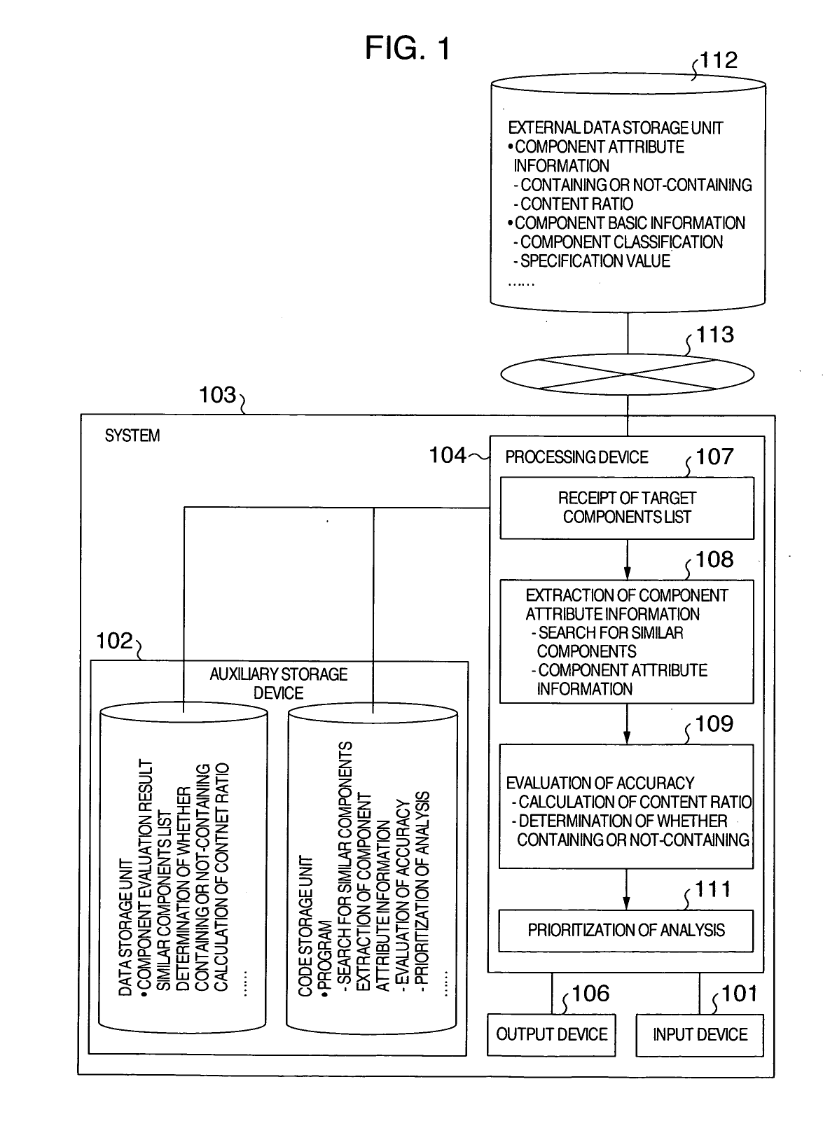

A block diagram of the system in the present embodiment is shown in FIG. 1. This shows a case in which components are assumed to be objects. A processing device 104 executes each calculation processing of receiving a target components list (step 107), extracting component attribute information (step 108), evaluating accuracy (step 109), and setting an order of priority for analysis (step 111). It should be noted that while each step of 107 to 109, and 111 is implemented by executing software by means of such a general-purpose information processing apparatus in the present embodiment, the present invention is not limited to that, and the foregoing can also be implemented in combination with dedicated hardware or the like. Moreover, while FIG. 1 shows a case in which component attribute information, such as the composition of contained chemical substances or the like, and basic information of the components, such as component classification, specification values, or the like, are stored in the external data storage unit 112, and a similar components list, and the result of determination/calculation of components, such as determination of whether containing or not-containing, calculation of content ratio, or the like, are held in a data storage unit within the system 103, it does not matter whether the component attribute information, and basic information of the components are stored in the external storage unit or in the internal storage unit when they are actually stored. However, intermediate evaluation results (such as a similar components list 209, a database 311, a database 416, or the like) are preferably stored in an auxiliary storage device 102 within the system.

(2) Search for Similar Components

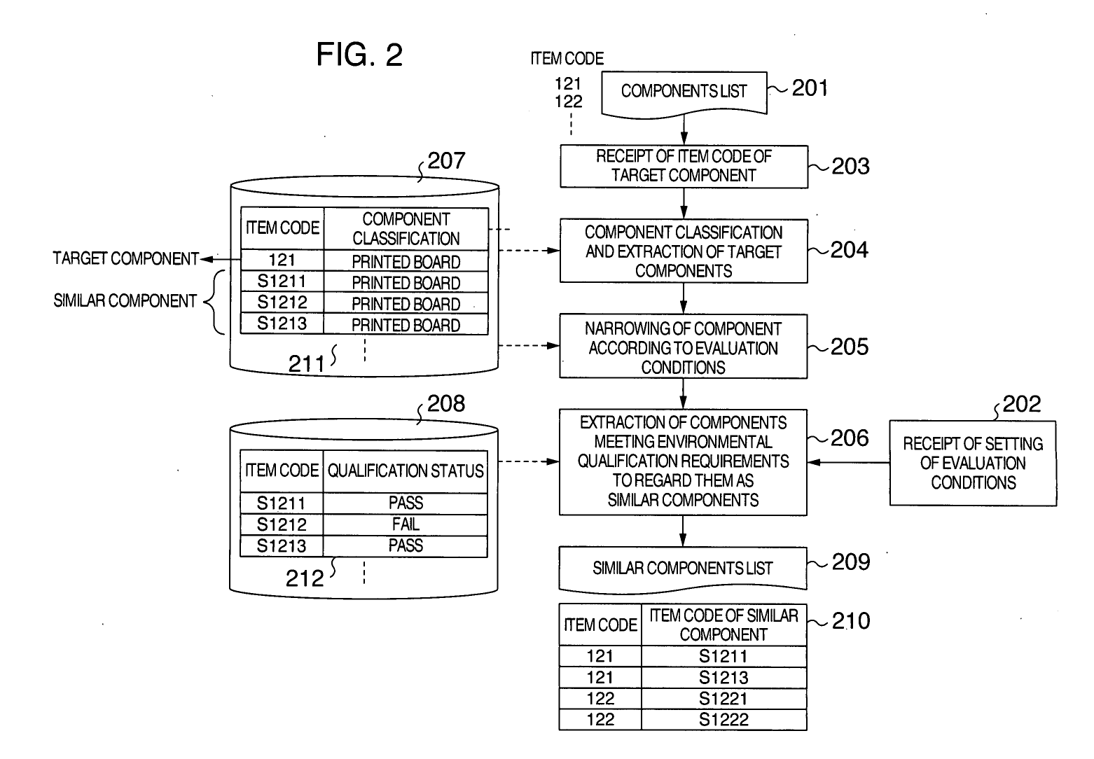

Next, details of each step in calculation processing will be described in accordance with flow charts in FIGS. 2 to 5. FIG. 2 is the flow chart of the processing (step 108) for extracting component attribute information. The similar components basically belong to the same component classification as the target components. While the components can also be classified according to production places, manufactures, or the like, they are classified according to functions and structures in the following sections of the present invention. In other words, the components having similar functions and structures are defined to belong to the same group of components. At this time, each group of components is formed according to the type of the components, such as a resistor, a capacitor, or the like. A parent-child relationship between the components is sometimes considered in classifying the components (e.g. film resistor, carbon resistor, and chip resistor belong to resistor). The system 103 receives a components list 201 in which item codes of target components inputted by users are recorded (step 203). At this time, the received item codes of the components list may be defined according to the item codes handled by the organization to which the users belong, or according to the item codes handled by the manufactures, and the number of the attributes may be one or both of them.

Item codes of the target components are extracted from the received components list 201, and the component classification of the target components is specified based on Table 211 stored in an external storage device 207 (step 204). The Table 211 holds data for linking the item codes to component classifications. The component classifications in the Table 211 shown in FIG. 2 hold character strings. However, component classification codes may also be adopted that are shown in combination with such symbols as alphanumeric characters that are defined by JEITA (Japan Electronics and Information Technology Industries Association) as an ECALS.

Furthermore, the item codes of the components belonging to the same component classifications that are specified in step 204 are extracted from the Table 211 (step 205). An evaluation conditions setting and receiving interface 202 of the system can receive conditions that lead to narrowing of similar components to further narrow down the components extracted at the step 205 (step 206). FIG. 2 shows a case in which a database 208 holds Table 212 that includes information on environmental qualification status, and components are narrowed down to those that are qualified in the environmental qualification status. However, the narrowing conditions can include a registration date of the component information, suppliers, an operation division to which the user belongs, or the like, in addition to those described in the present embodiment.

The system outputs a linkage between the target components and the similar components that are narrowed down in this way as a list 209. The list 209 is held in the main storage device or in the auxiliary storage within the system.

(3) The Concept of Determination of Whether Containing or Not-Containing (Containing or Not-Containing Evaluation) and Calculation of Content Ratio (Content Ratio Evaluation)

Next, an explanation will be given to processing that compares chemical substance information of the target components with that of similar components using information on containing or not-containing and information on content ratio at the accuracy evaluation step (step 109) to obtain the degree of similarity.

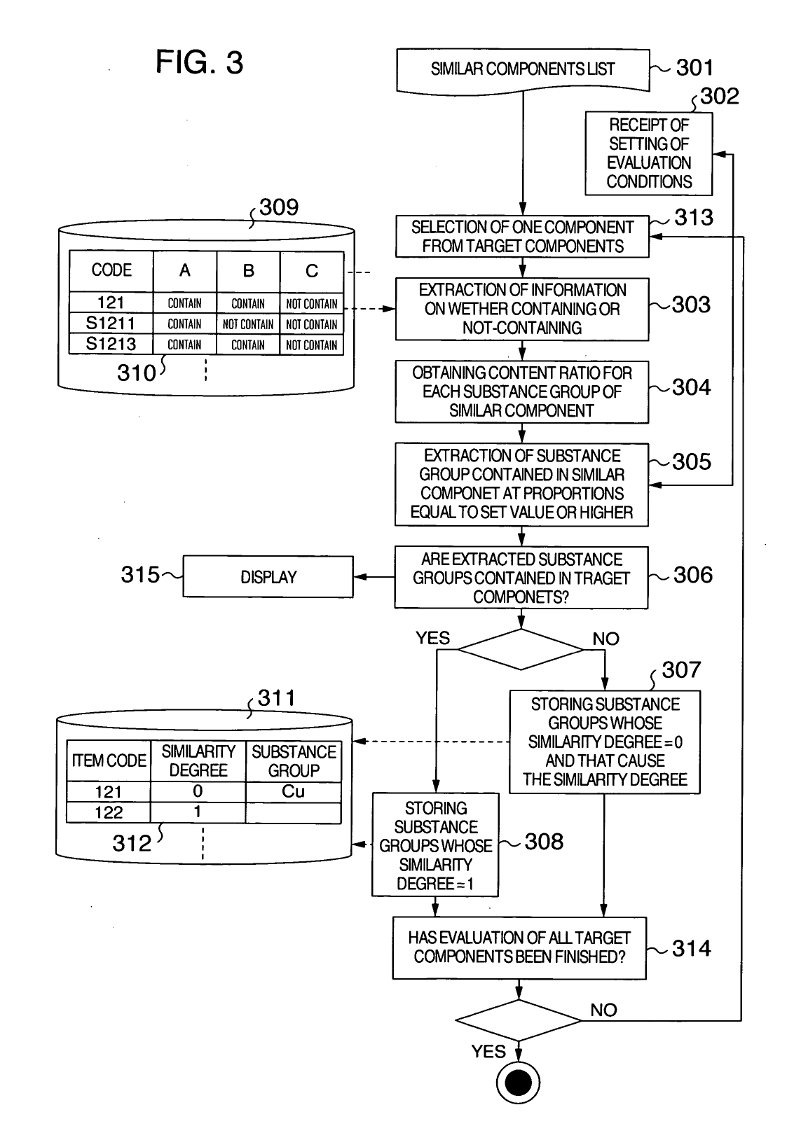

The information on whether containing or not-containing indicates whether each substance group is contained in each item code, as shown in Table 310 of FIG. 3. While the number of substance groups (i.e. the number of columns) is not limited, it typically includes about 20 to 30. “Contain”, “not contain” or “under inspection” is inserted into the sections that indicate containing or not-containing. Here, the substance group refers to the group of chemical substances having a common item. For example, if cadmium, a target chemical substance regulated by the RoHS directive, is a common item, the simple substance of cadmium and a compound thereof (e.g. cadmium oxide or the like) are contained in the substance group of “cadmium and compound thereof”. Moreover, if the substance group is “a noble gas”, it comprises helium, neon, argon, krypton, xenon, and radon.

The chemical substance described here refers to a component that corresponds to a substance code in a one-to-one relationship. The substance code defines a symbol inherent to the element or compound thereof. Typically, CAS numbers (CAS Registry Numbers) that are defined by American Chemical Society are employed.

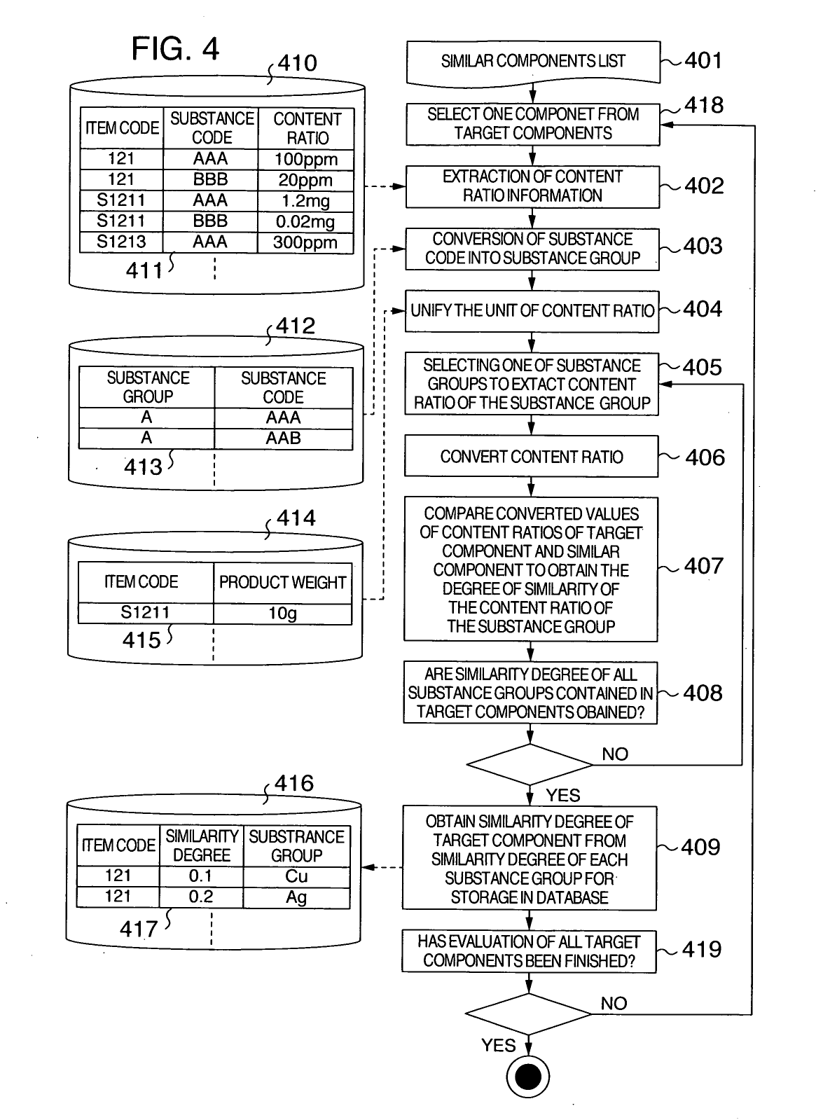

Information on content ratio refers to the information in which substance code and content ratio are linked to the item code, as is shown by Table 411 in FIG. 4. Although the content ratio is typically indicated by ppm (part per million), weight percent and a contained amount (mg. g, kg) may also be accepted.

The determination of whether containing or not-containing and the calculation of content ratio are used instantaneously in the processing of obtaining the degree of similarity. There are two reasons why the two processes are instantaneously used as in the following. With just the determination of whether containing or not-containing, it is impossible to differentiate between the codes with “contain.” The defect is complemented by the calculation of content ratio. On the other hand, with just the calculation of content ratio, it is impossible to verify that certain chemical substances are not contained. The defect is complemented by the determination of whether containing or not-containing. In this way, these two evaluation processes are preferably performed simultaneously so as to complement defects of each other.

However, it should be noted that while the attribute information used for evaluation refers to the information on whether containing or not-containing or information on content ratio for each substance group in the present embodiments that follow, when comparing chemical substance information, it is not necessary to limit the attribute information to the substance group. For example, if the present embodiment aims to evaluate not only the chemical substance information but also the accuracy of the information provided by suppliers itself, specification values (temperature characteristic or resistance value in the case of a resistor, and capacitance or the like in the case of a capacitor), and weight of the component can be employed as attribute information.

Furthermore, evaluation can also be executed by narrowing the attribute information. It is unnecessary to make a comparison using the information on whether containing or no-containing for all substance groups that number about 20 to 30. For example, in order to improve the accuracy of the evaluation, it is also possible to narrow the attribute information to the information on substance groups that are provided from suppliers and include a lot of information.

(4) The Determination of Whether Containing or Not-Containing (Containing or Non-Containing Evaluation)

FIG. 3 is a flow chart for the determination of whether containing or not-containing in the evaluation of accuracy (step 109). The system receives a similar components list 301 to the target components that are extracted at step 108. At step 313, the system extracts one of the target components from the similar components list. At this time, a record of the target components may be extracted from the target components list 201 received at step 107.

At step 303, the information on whether the target components and components similar to them contain or do not contain the chemical substances is extracted from a database 309.

At step 304, the content ratio for each substance group contained in the similar components is obtained. In other words, assuming that the number of items in the similar components is N, the number of items that “contain” a substance group A is NY, the number of items that “do not contain” the substance group A is NN, the number of items that are “under inspection” on whether containing or not containing the substance group A, or that are not registered is NU, and the content ratio of the substance group A is PA, the content ratio of the substance group A is obtained by the following expression.

$${P}_{A} = 100 \times \frac{{N}_{Y}}{{N}_{Y} + {N}_{N}} = 100 \times \frac{{N}_{Y}}{N - {N}_{U}} [ \% ] \qquad [ expression 3 ]$$

Where, NY+NN+NU=N. The expression 3 is used to obtain the content ratio for all substance groups.

At step 305, a substance group that is contained in almost all similar components is extracted in accordance with a set value, input of which is received at an interface 302 for setting and receiving evaluation conditions. A threshold value of the content ratio is mainly assumed as the set value received at 302, and at step 305, substance groups, which are contained in the similar components in the proportion equal to the set value or more, are extracted. In addition, the set value can be set for each component classification and for each substance group. Alternately, a value, which is set such that x (arbitrary number) pieces, of substance groups which are contained in high proportions are extracted, can also be received.

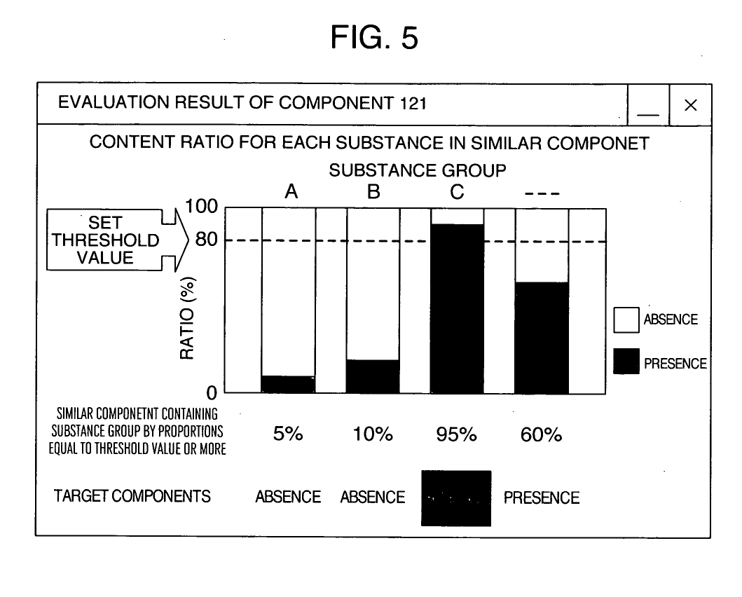

At step 306, it is checked whether the substance groups extracted at the step 305 are contained in the target components. If all the extracted substance groups turn out to be contained, the similarity degree of the target component is set to 1, and a record is stored in a database 311 that stores the result of checking if the substance groups are contained at step 308. The database 311 is preferably constructed in an auxiliary storage within the system. If at least one of the extracted substance groups is not contained, the similarity degree of the target component is set to 0, and a record is stored in the database 311 together with a substance group (sometimes a plurality of substance groups) that is (are) not contained in the target component at step 307. An exemplary display of the checking result at this point is shown in FIG. 5. It should be noted that the database 311 exists in a main storage device or in an auxiliary storage device that are held in the system. The structure of the Table 312 has columns for holding at least the item code, the degree of similarity, information on substance groups.

At step 314, the similar components list 301 and the database 311 are referred to, and if the evaluation of all the target components is not finished, the flow returns to step 313, where target components that are not inspected yet are evaluated in a similar way. When the evaluation of all the target components is finished, the check of whether the substance groups are contained terminates.

(5) The Calculation of Content Ratio (Content Ratio Evaluation)

FIG. 4 is a flow chart for the calculation of content ratio in the evaluation of accuracy (step 109). The system receives a list 401 of components similar to the target components that are extracted at step 108. At step 418, one of the target components is extracted from the similar components list. At this time, the record of the target components may be extracted from a target components list 101 that is received at step 107.

At step 402, information on the content ratio in the target components and their similar components is extracted from a database 410.

In Table 411 stored in the database 410, substance codes and content ratio are linked to item codes. However, codes inherent to elements and compounds like CAS numbers are sometimes used for the substance codes. Here, in order to totalize the content ratio for each chemical substance on a substance group basis, Table 413 for holding information relating to unit conversion, which is stored in a database 412, is used to convert the substance codes into substance groups and into the content ratio by unit of a substance group (step 403). At this time, the Table 413 includes columns for at least substance groups and substance codes. The Table 413 sometimes includes columns for metal conversion coefficients. The metal conversion coefficients are values for converting the content ratio of chemical substances that include metal into the content ratio of metal itself.

Furthermore, at step 404, the unit of content ratio in Table 411 is unified into ppm. At this time, if the column of the content ratio includes information equivalent to contained amount (mg, g, kg, or the like), reference is made to Table 415 holding information on the component attribution that is stored in a database 414 in order to convert the information into content ratio. The information on component weight stored in the table is extracted, and the contained weight is divided by component weight for conversion into content ratio in ppm.

At steps 406 to 409, the degree of similarity of the information on the content ratio is obtained by comparing the content ratio of the target components with the content ratio of the similar components. In the following sections, an evaluation method will be described on the assumption that the distribution of content ratio of the similar components approximates the normal distribution. However, the evaluation method is exemplary and is not restricted to the one described in the present embodiments as far as the method is capable of defining continuous similarity.

Step 406 is the processing of converting the content ratio of the target components and similar components. It is an object of the processing to extract the characteristic of the distribution of the content ratio. For example, a cube root of the content ratio is taken. In many cases, it is difficult to limit the range of the content ratio without being subjected to the processing. Especially, the processing is useful when extracting excessively small content ratio, since it is possible to emphasize small values by executing conversion using a function in which as x (content ratio) increases like y=x1/3 or y=log x, so the rate of increase of y (conversion value of content ratio) gradually decreases.

Step 407 is the processing of obtaining the similarity degree of the content ratio of the target components. First, one substance group is selected (tentatively assuming that this is a substance group A) and an average value mA and a standard deviationσA of the distribution of a cubic root of the content ratio of the similar components that are converted at step 406 are obtained. At this time, similar components that do not contain the substance group are not considered in obtaining the average value and standard deviation. Next, assuming that the distribution follows the normal distribution, a value PA is obtained when the cubic root of the content ratio of the substance group A of the target component is CA.

$${P}_{A} = \frac{1}{\sqrt{2 π}} {\int }_{- ∞}^{k} {ⅇ}^{- \frac{{u}^{2}}{2}} ⅆ u \qquad [ expression 4 ]$$

where

$$k = \frac{1}{{σ}_{A}} ( {C}_{A} - {m}_{A} ) \qquad [ expression 5 ]$$

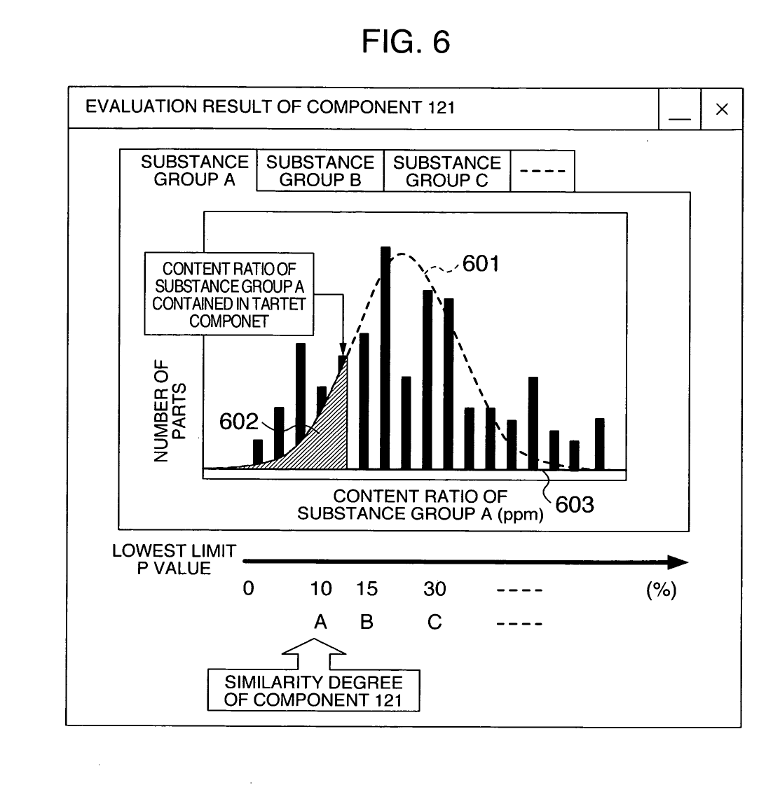

The PA is an area shown by a shaded part 602 in FIG. 6. Since the area surrounded by a curve 601 of the normal distribution and a horizontal axis 603 is 1, then 0<PA<1.

At step 408, it is confirmed if Pi, which is defined by expression 4, is obtained in all substance groups i that are contained in the target components, and if not obtained, the processings of steps 405 to 407 are repeated.

In this manner, Pi is obtained for all substance groups. Step 409 is the processing for obtaining the similarity degree of the target component based on Pi. As an exemplary definition method of similarity degree S, a minimum value of Pi is taken in the present embodiment. This is an exemplary embodiment in which the substance group with low accuracy, if any of all substance groups, is extracted. However, the definition of the similarity degree is not limited to taking the minimum value. For example, it is possible to evaluate the degree of similarity as the entire chemical substance information by taking an average value of Pi. Then, a substance group that gives the similarity degree S and the minimum Pi of the target component is stored in Table 417 that stores the result of the calculation of content ratio in a database 416. It should be noted that the database 416 exists in a main storage device or an auxiliary storage held within the system.

Then, at step 419, reference is made to a components list 401. If the calculation of content ratio is not finished for all target components, the flow returns to step 418, where the degree of similarity is obtained for the components that are not inspected yet. If the inspection of all target components is finished, the calculation of the content ratio terminates.

(6) Setting an Order of Priority for Analysis

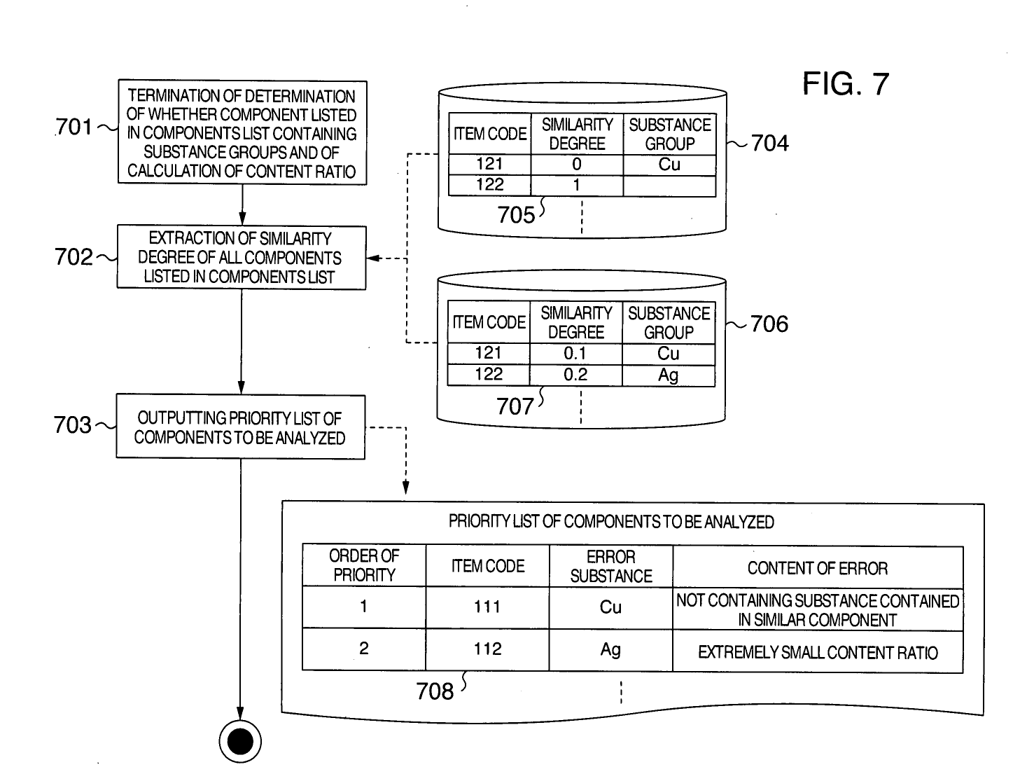

FIG. 7 is a flow chart for setting an order of priority for analysis (step 111). The system recognizes the termination of the accuracy evaluation (step 109) of all target components.

At step 702, the degree of similarity for all target components described in the target components list 101 is extracted from Table 705, which stores the result of determination of whether containing the substance groups or not, and from Table 707, which stores the result of the calculation of the content ratio. When one target component is subjected to the processes of the determination of whether containing or not-containing as well as the calculation of the content ratio, two different similarity degrees are defined or provided by the two evaluation processes. However, in the present embodiment, the degree of similarity with a lower value out of the two similarity degrees provided is regarded as the similarity degree of the target component. At this time, data relating to the substance groups, which are linked to the item codes from the Table 705 or Table 707, are also simultaneously extracted.

At step 703, the target components in the components list 101 are prioritized in the order of ascending degree of similarity, and a priority list of components to be analyzed 708 is outputted. Although the output is in a form that is stored as a file, it can also be displayed on the screen.

The above processes enable incorrect suppliers' information to be extracted. A method of effectively extracting incorrect information by means of above processes is introduced in the following sections.

As one principal example of incorrect information provided by suppliers, a fixed resistor equipped with lead wires will be given. In the fixed resistor, components are constituted of a plurality of sites, and sometimes there are errors included in the information provided by the suppliers. A fluorescent X-rays analyzer can analyze only very small parts when it is employed for the analysis of content ratio. Therefore, when analyzing a component that comprises a plurality of sites, it is necessary to analyze all sites that constitute the component. Otherwise, there is a possibility that a certain chemical substance contained fails to be detected. When the suppliers actually provide information without noticing such detection failures, the information provided by the suppliers is correct in terms of the content ratio of almost all chemical substances. At this time, the suppliers provide the information that the content ratio of the chemical substance in question is extremely low, or that the chemical substance “is not contained.”

Above processes of the present invention are effective in this instance. When the content ratio is very low according to the information provided by suppliers, the processes of the present invention compare the target component with similar component in terms of the content ratio inspected, and the chemical substance that fails to be detected is determined as “similarity degree is low” in content ratio. In the case of the chemical substance that “is not contained” according to the information provided by suppliers, the target component is compared with the similar component in terms of whether containing or not containing and is determined as “similarity degree is low” in the same way.

### Embodiment 2

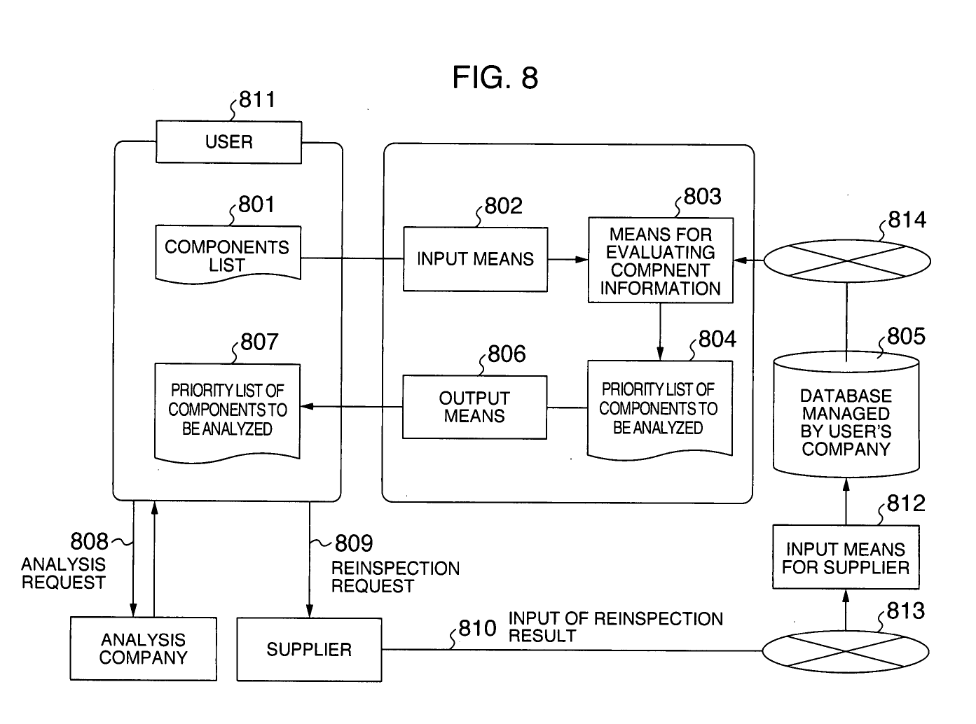

FIG. 8 shows an embodiment in which users employ the system when performing design and quality assurance.

When the system is used at a design stage, a user 811 may possibly be design staff, quality assurance staff, or procurement staff. The system receives a target components list 801 which is inputted by the user through an input means 802, and generates a priority list of components to be analyzed 804 via a components information evaluation means 803. The evaluation means 803 is connected to a database managed by user's company 805 via a network 814 and is capable of obtaining components information including similar components. The system outputs the priority list of components to be analyzed 807 to the user via an output means 806. In the outputted priority list of components to be analyzed, item codes of components, the name of a substance group with lowest accuracy, and determination reasons are described (list 708 in FIG. 7). When the user 811 files a reinspection request with the supplier based on the priority list of components to be analyzed 807, the supplier follows the list 807 to intensively reinspect the substance groups with low accuracy. The database managed by the user's company 805 is connected to the supplier input means 812 via a network 813. This enables the database managed by user's company 805 to receive an input 810 of the result of reinspection.

When filing a request for analysis 808, the user can also send the priority list of components to be analyzed 807 to an analyzing company. In the operational flow, there is something that must be done before filing a request with the supplier for reinspection so as to recognize the determination result of the system. Also in this case, the analyzing company intensively analyzes the substance groups with low accuracy based on the contents outputted to the priority list of components to be analyzed 807. The accuracy of the information provided by third parties is effectively enhanced through the operational flow.

### Embodiment 3

When the system is used at a manufacture stage, the user may possibly be manufacture staff, quality assurance staff, or procurement staff. While an operational flow used at the manufacture stage does not basically differ from that used at the design stage, the components list prepared by the user sometimes includes lot numbers, serial numbers or the like, which allow the recognition of individual component data, in addition to item codes.

### Embodiment 4

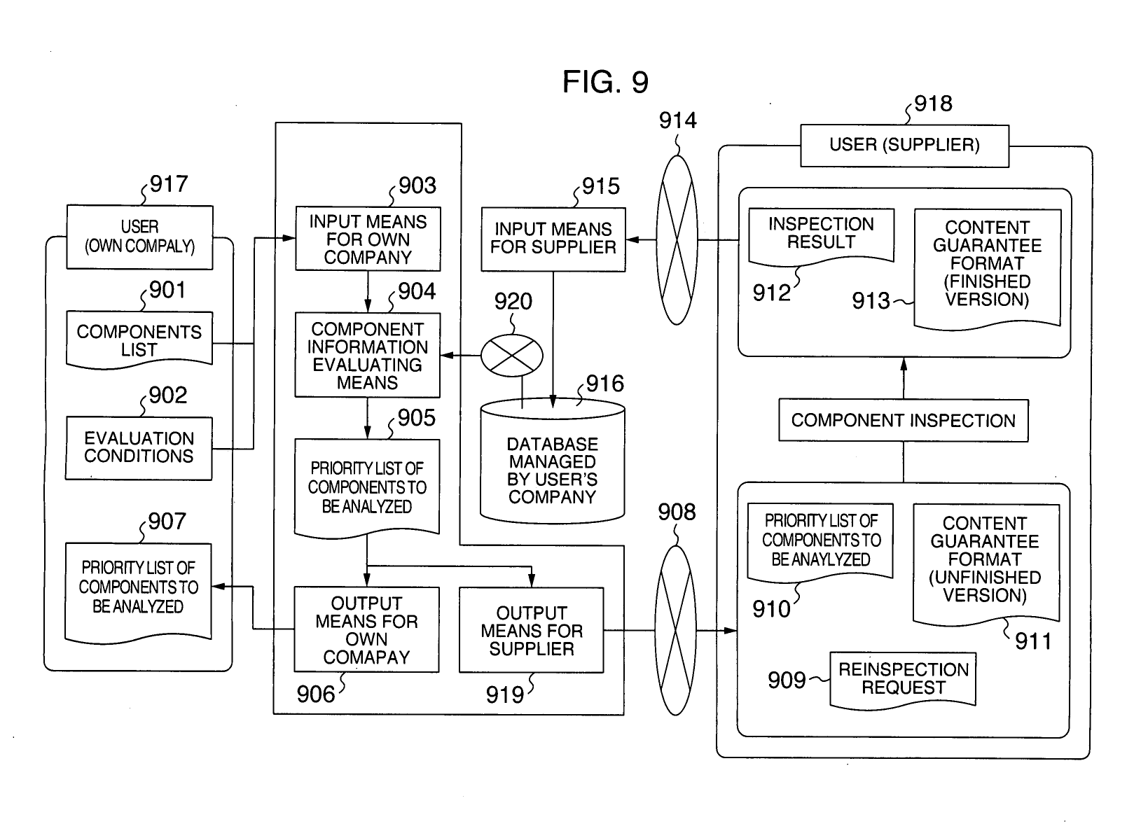

FIG. 9 shows an embodiment in which the system employing the present invention is used directly by suppliers.

In this case, a case is assumed in which the system is used by assembly manufactures as well as suppliers. First, the system receives a components list 901 and evaluation conditions 902 through an input means for the assembly manufactures.

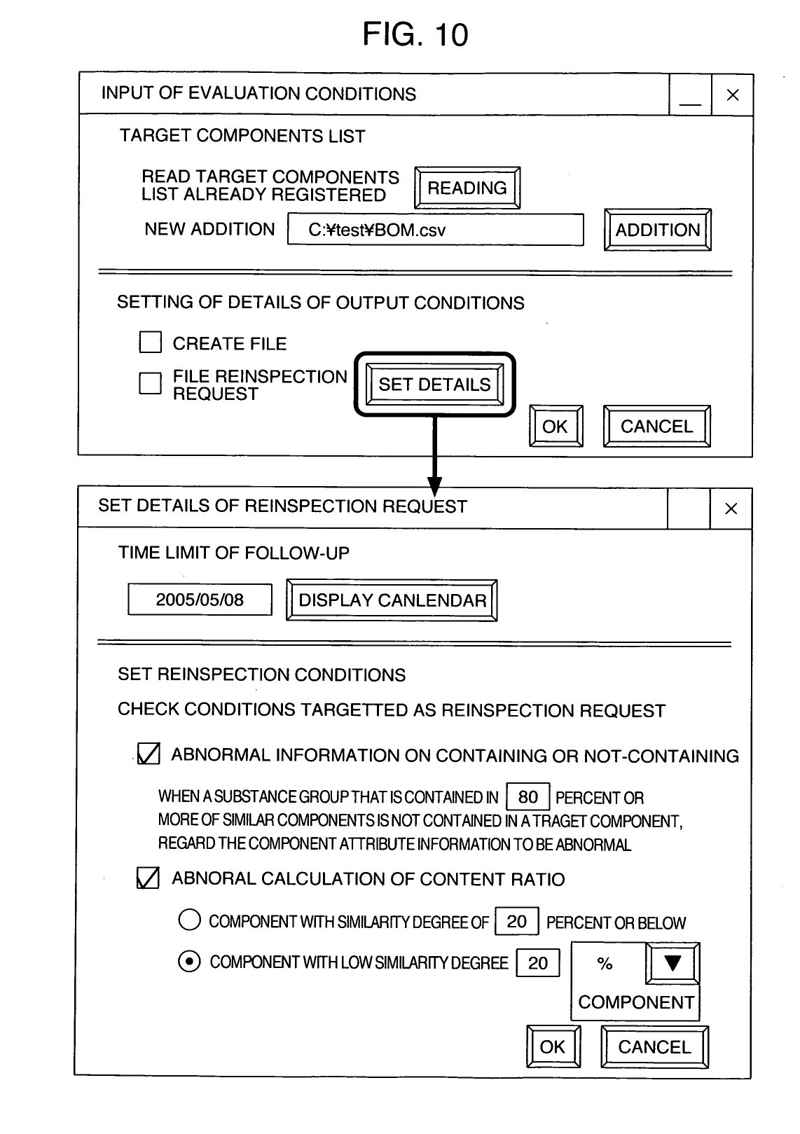

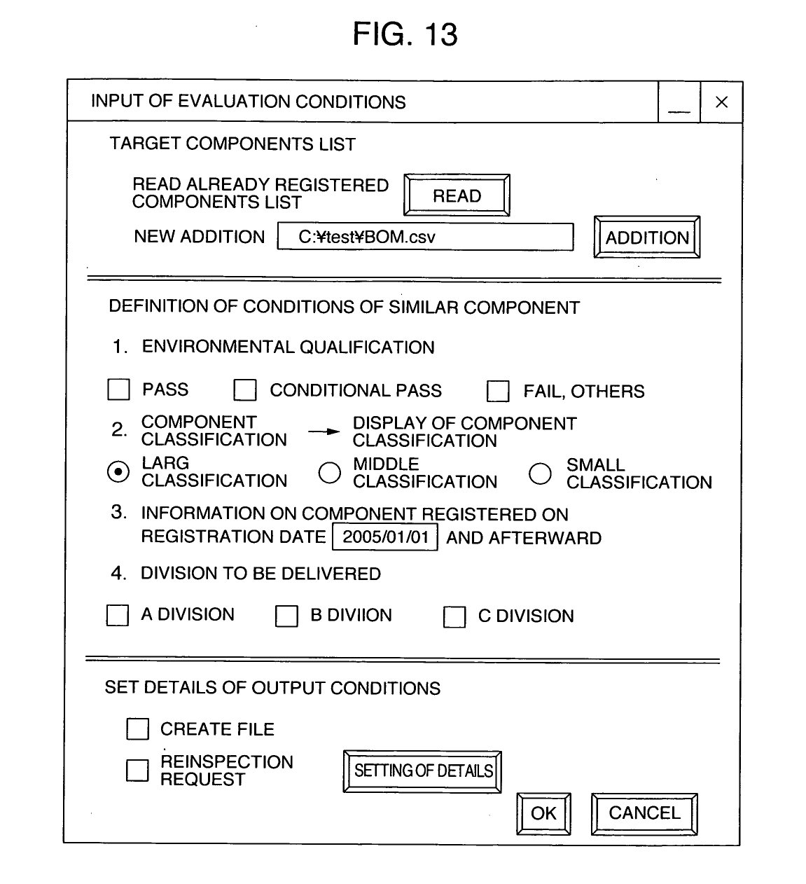

An exemplary input interface screen of the evaluation conditions 902 is shown in FIG. 10. A characteristic of the screen is that a “follow-up time limit,” which is a time limit for registering the result of reinspection, and “setting of reinspection conditions” for setting conditions of the components that should be reinspected can be inputted as setting a request of reinspection. Another example of the input interface screen of the evaluation conditions 902 is shown in FIG. 13. This is an example of the input screen which enables the user to define the conditions of similar components in a detailed manner. As the screen sample shows, the similar component can be defined by environmental qualification, component classification, registration date, and supplier division. In addition to these, a case can be considered in which the similar component is narrowed down by specification values (temperature characteristic or resistance in case of a resistor, capacitance in case of a capacitor, or the like) for each component classification, the weight of the component, or the like.

The system receives the evaluation conditions 902 to generate a priority list of components to be analyzed 905 via a component information evaluation means 904. Then, the system retrieves information such as a mail address or the like of the supplier from a database managed by user's company 916 to file a request for registration from an output means 919 for the supplier via a network 908, and transmits a reinspection request 909, a priority list of components to be analyzed 910, and a content guarantee format 911 to a supplier 918.

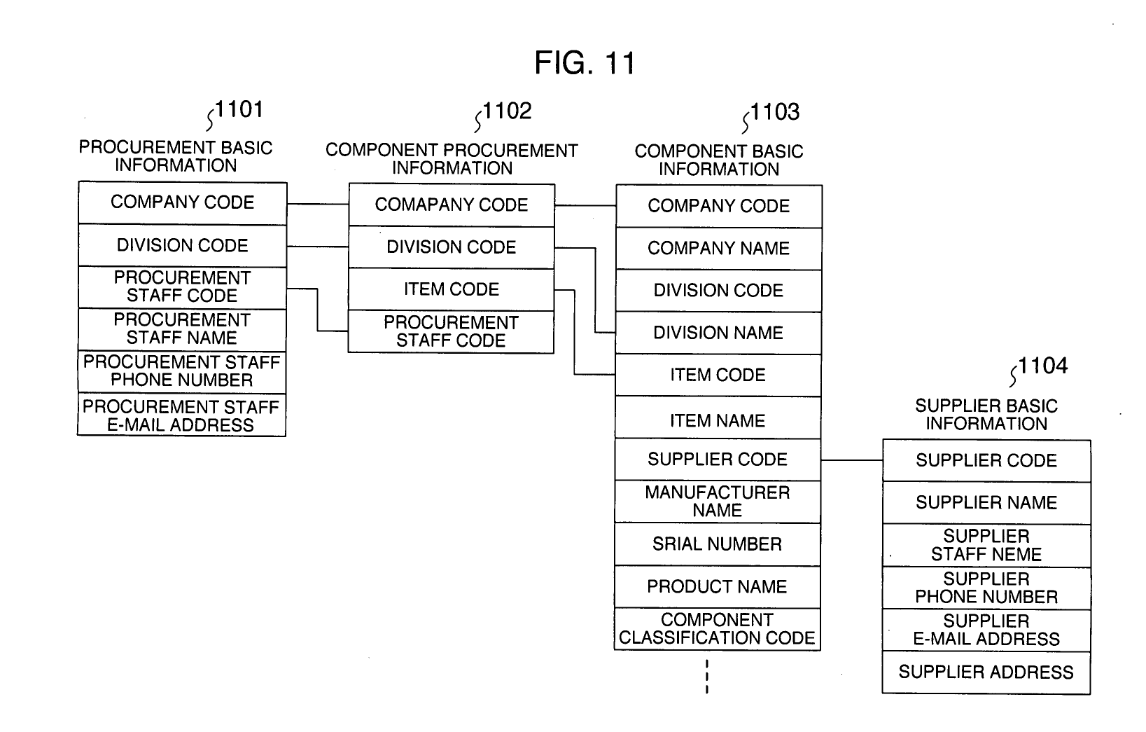

In the present embodiment, the output means 919 for the supplier directly files a request with the supplier for registration via a network 908, thus needing no manual operations by the assembly manufacture 917. In order to achieve this, supplier basic information Table 1104 is stored in the database-managed by user's company 916. Since item codes are specified in the components list 901, (one or a plurality of) suppliers for the item codes are specified via component basic information Table 1103 that is held in the database managed by user's company 916, and basic information, such as the name, mail address, address or the like of the staff on duty of the supplier, is linked from the supplier basic information Table 1104 by using a supplier's code as a key. While some of the supplier basic information is illustrated in FIG. 11, there is no limit to them when there is some information that is necessary for filing a registration request and that depends on the supplier.

User basic information on the side of a customer, besides the supplier basic information, can also be linked to the item code in a similar way. For example, a registration request is performed by procurement staff of almost all manufactures. When managing the procurement staff for each item code, the item code is linked to the procurement staff code from component procurement information Table 1102. Then, the item code is linked to the name, mail address, or the like of the procurement staff from procurement basic information Table 1101 by using company code, business place, staff code as a key. By linking basic information on the customer side as well as on the supplier side to the item code in this way, it becomes possible to perform the registration request not only by E mail via the network, but also by direct mail or the like.

Alternately, the supplier can download a reinspection request 909, a priority list of components to be analyzed 910, and a content guarantee format 911 directly from the system via the network 908. When performing the registration request by mail, the system can not only mail a reinspection request, but also append the priority list of components to be analyzed 910 and the content guarantee format 911 to the mail at the same time. In the content of the reinspection request mail 909, a reply deadline of the reinspection and a contact point serving as a window to the customer are described. This information is held in the database managed by user's company 913.

The content guarantee format 911 guarantees the composition of the chemical substances contained in the components to be reinspected. In addition to 6 substance groups (Cd, Pb, Cr(VI), Hg, PBB, PBDE) which are regulated by the RoHS directive, substance groups that are determined to be possibly inaccurate in the priority list of components to be analyzed 910 may also be included in the substance group to be guaranteed in content thereof. The supplier can complement the information such as a content ratio, a contained site, or an object of the target chemical substances to the content guarantee format 911 outputted by the system, access to the database managed by user's company 916 from the input means for supplier 915 via the network 914, and perform the registration of the content guarantee 913.

It is possible to facilitate the procurement of components and to reduce man-hours for design and approval by making the information communication means between the own company (the assembly manufacture) 917 and the supplier 918 seamless in accordance with the present embodiment.

It should be noted that while the present embodiment includes the composition of chemical substances contained in components as attribute information to be evaluated, and components belonging to the same component classification as comparison targets, a combination of attribute information and comparison targets to which the present invention can be adapted is not limited to them. The present invention is also adaptable to the information which is provided by third parties and of which truth is difficult to determine. Here, the third party includes an entity having a data generation function such as measurement equipment or the like in addition to persons and corporations. The sample, to which the present invention is adapted, other than the chemical substance information of components is considered to include the following:

Environmental Load information such as CO2 emission, or energy usage at a component manufacturing stage. Components that belong to the same component classification, and are used as comparison objects.

Information on materials that constitute the components. Components that belong to the same component classification, and are used as comparison objects.

Specification values of components and errors in the specification values. The components that belong to the same component classification, are similar in the unit price, and are used as comparison objects.

There are other examples to which the present invention is adaptable even in a field that has nothing to do with assembly manufactures as follows:

Health checkup data of examinees (blood pressure, blood sugar level, or the like). Health checkup data of examinees of the same sex and age that are used as comparison objects.

Environmental Load information such as CO2 emission and energy usage during operation of a machine. Machines having the same functions that are used as comparison objects.

It should be further understood by those skilled in the art that although the foregoing description has been made on embodiments of the invention, the invention is not limited thereto and various changes and modifications may be made without departing from the spirit of the invention and the scope of the appended claims.

1. An incorrect component attribute information extracting method for calculating and displaying priorities when checking information on containing of substance groups in a plurality of target components, the incorrect component attribute information extracting method comprising the steps of:
searching information on similar components that are already registered and belong to the same component classification with target components or satisfy inputted evaluation conditions from a database;
selecting substance groups, which are contained in all pertaining similar components by proportions satisfying a predetermined value, from information on whether containing or not-containing for each substance group held in said similar component information to determine whether said selected substance groups are contained and to determine a first similarity degree of said pertinent target components;
sequentially selecting each substance group i from the content ratio information for each substance group held in said similar component information to obtain an average value mi and a standard deviation σi of distribution of content ratio cube root of a substance group i in each similar component and determine a minimum value in Pi of each substance group i or an average value of Pi which is obtained using next expression is determined to be a second similarity degree by a content ratio cube root Ci of the substance group i in said pertinent target component;
$$Pi = \frac{1}{\sqrt{2 π}} {\int }_{- ∞}^{k} {ⅇ}^{- \frac{{u}^{2}}{2}} ⅆ u \qquad [ expression 1 ]$$
where
$$k = \frac{1}{{σ}_{i}} ( {C}_{i} - {m}_{i} ) \qquad [ expression 2 ]$$
determining the degree of similarity with a lower value out of said first similarity degree and said second similarity degree as the similarity of said pertinent target component; and
giving priorities on checking information on containing of substance groups in said plurality of target components in the ascending order of said determined degree of similarity to display said priorities.

2. The incorrect component attribute information extracting method according to claim 1, wherein conditions of environmental qualification, component classification, registration dates, or divisions to which components are delivered are set from a setting and inputting screen as evaluation conditions for defining said similar components.

3. An incorrect object attribute information extracting system comprising an object attribute information evaluating system for evaluating the accuracy of attribute information of an object provided by a third party, said object attribute information evaluating system comprising:
an input unit;
an output unit;
a calculation unit; and
a storage unit comprising an object basic information table for defining a classification to which the object belongs, and an object attribute information table for holding the object attribute information,
wherein said calculation unit comprises:
means for receiving a target objects list and evaluation conditions via said input unit;
means for extracting similar objects to the target objects that are listed in said target objects list to extract said target objects and attribute information of said similar objects;
means for comparing said target objects with the attribute information of said similar objects to evaluate the accuracy of said target objects; and
means for giving a priority to the accuracy of attribute information of each object in said target objects list.

4. The incorrect object attribute information extracting system according to claim 3, wherein said calculation unit further comprises:
means for receiving the target objects list and evaluation conditions in which reinspection conditions are set;
means for extracting objects that satisfy said reinspection conditions after evaluating the accuracy of the object attribute information to file a request with a provider of said object attribute information for reinspection; and
means for appending a inspection format in which causes and cause attributes of reinspection are specified.

5. An incorrect object attribute information extracting method, wherein a method for evaluating the accuracy of the attribute information of an object comprises the steps of:
determining the presence or absence of accuracy in the attribute information of said target objects based on the distribution of the attribute information of said similar object when a variable value of the attribute information is limited, and specifying said reason of said determination when determining that the accuracy is absent; and
quantitatively evaluating the degree of accuracy of the attribute information of said target object based on the distribution of the attribute information of said similar object to specify the reason of said evaluation when the variable value of the attribute information is unlimited.

6. The incorrect object attribute information extracting method according to claim 5, wherein the method for evaluating the accuracy of the object attribute information further comprises the steps of:
converting said attribute information when the attribute information is represented by a comparison scale or an interval scale; and
using the converted attribute information to evaluate the degree of accuracy of the attribute information of said target object based on the distribution of the attribute information of said similar object and specify the reason of said evaluation.

7. The incorrect object attribute information extracting method according to claim 5, wherein the method for specifying the attribute and reason causing reinspection of the object attribute information further comprises the steps of:
specifying cause attributes for reducing the degree of accuracy; and
specifying causes for reducing the degree of accuracy.

8. The incorrect object attribute information extracting system according to claim 3, wherein said output unit further comprises means for sorting the object in which causes as well as cause attributes that reduce the degree of accuracy of the object attribute information are specified in the order of ascending degrees of accuracy and outputting them.

9. The incorrect object attribute information extracting system according to claim 3, wherein said output unit further comprises means for outputting a reinspection format relating to the cause attributes that reduce the degree of accuracy of the object attribute information, and said input unit further comprises means for receiving said reinspection format, in which the object attribute information whose inspection is finished is inputted, to store said object attribute information in the database managed by user's company.
